(19) United States
(12) Patent Application Publication
(10) Pub. No.: US 2008/0187237 A1
(43) Pub. Date: Aug. 7, 2008

(54) Method, medium, and system reducing image block noise

(75) Inventors: Seung-sin Lee, Yongin-si (KR); Du-sik Park, Suwon-si (KR); In-so Kweon, Suwon-si (KR); Rock-hun Do, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/979,745

(22) Filed: Nov. 7, 2007

(30) Foreign Application Priority Data
Feb. 7, 2007 (KR) 10-2007-0012847

(51) Int. Cl. G06K 9/36

(52) U.S. Cl. 382/268

(57) ABSTRACT

A method, medium, and system reducing block noise of a digital image, including an encoding/decoding method, medium, and system. The method of reducing block noise of a digital image includes calculating a value of a boundary block that includes a boundary between two neighboring blocks, calculating the visibility of the boundary block by extracting specified characteristic values of the boundary block, classifying the boundary block according to a result of comparing the calculated visibility with a specified threshold value and whether the two neighboring blocks are corner blocks, and performing deblocking of the two neighboring blocks according to a result of classification.

### CROSS-REFERENCE TO RELATED APPLICATIONS

This application is based on and claims priority from Korean Patent Application No. 10-2007-0012847, filed on Feb. 7, 2007 in the Korean Intellectual Property Office, the disclosure of which is incorporated herein in its entirety by reference.

### BACKGROUND

1. Field

One or more embodiments of the present invention relate to a video compression technology, and, more particularly, to a method, medium, and system reducing block noise of a digital image, such as in an encoding/decoding method, medium, and system that can reduce block noise of an image encoded/decoded by block-based coding.

2. Description of the Related Art

With the development of information and communication technologies, there has been an increase in multimedia services that can accommodate diverse forms of information, such as text, image, music, etc. Since multimedia data is typically quite large, mass storage media and wide bandwidths are respectively desired for such storage and transmission. Accordingly, compression coding techniques have been found desirable for storage and transmission of multimedia data.

A basic principle of data compression is to remove data redundancy. Data can be compressed by removing spatial redundancy such as a repetition of the same color or object in images, temporal redundancy such as similar neighboring frames in moving images or continuous repetition of sounds and visual/perceptual redundancy, which considers human insensitivity to high frequencies. Data compression can be classified into lossy/lossless compression, intraframe/interframe compression, and symmetric/asymmetric compression, depending on whether there is a loss of source data, whether compression is made with respect to respective frames, and whether the time required for compression is equal to that required for restoration, for example. In a general video coding technique, temporal redundancy is removed by temporal filtering based on motion compensation, and spatial redundancy is removed by a spatial transform.

In order to transmit such compressed multimedia after the redundancy has been removed, transmission media are used, the performances of which differ. Presently used transmission media have diverse transmission speeds. For example, an ultrahigh-speed communication network may transmit several tens of megabits of data per second, while a mobile communication network may only have a transmission speed of 384 kilobits per second.

In such environments, an agreed upon H.264 coding standard is capable of achieving a compression ratio double that of MPEG-2, currently a compression standard for DVDs and HDTV, and was published under cooperation of Video Coding Experts Group (VCEG) and Moving Picture Experts Group (MPEG), with the common support of ISO/IEC (MPEG-4 Part 10) and ITU-T (Recommendation H.264), in 2003, for example. To implement this H.264 compression standard, many compression mechanisms related to encoding were used. However, as the number compression mechanisms is increased, information included in the original image becomes distorted. In addition, noise becomes mixed with the image in the process of compressing the image and/or in the process of transmitting the compressed image. In particular, the compression ratio becomes restricted due to blocking effects, such as unnecessary blurring effects or ringing effects, occurring in an encoding process through the use of a discrete cosine transform (DCT). This is because many high-frequency components are removed in such a DCT coefficient quantization process, and this causes the occurrence of the blocking effects. Here, the quantization process means a process of converting the DCT coefficients, expressed as certain real values, into discrete values according to a quantization table, and matching the discrete values with corresponding indexes. In this case, since the respective block is independently encoded, the respective restored images show visual discontinuity on block boundaries.

FIG. 1 illustrates blocking effects appearing when an original image is compressed. Referring to FIG. 1, the image 11 corresponds to the original image, and the image 12 corresponds to an image obtained by encoding the original image at a compression rate of 1% using a known JPEG coding standard. In FIG. 1, it can be seen that when a small number of bits is allocated for quantizing the results of the DCT, large blocking effects appear.

Conventionally, there has been a proposal to use diverse post-processing algorithms, which can remove such blocking effects as shown in FIG. 1, and which are compatible with the compression standard. As the simplest among them, there is a technique of implementing low pass filtering (LPF), a technique implementing Markov random fields (MRF), a blocking-effect removing technique implementing techniques for projecting onto convex sets (POCS), e.g., as proposed by Yongyi Yang, and for constrained least squares (CLS), a maximum a posterion (MAP) technique, and so forth.

However, these above-described techniques have problems in that since they remove high frequency components that are desirable for properly expressing the image, such that an image-blurring phenomenon may occur. In addition, since these techniques perform a repeated search for places having the minimum change, their real-time implementation may not be realistically possible.

### SUMMARY

Accordingly, one or more embodiments of the present invention have been set forth to solve the above-mentioned conventional problems, with an aspect of the present invention being to provide a method, medium, and system reducing block noise of a digital image, such as an encoding/decoding method, medium, and system that can provide a high-quality image by reducing block noise with respect to blocks having the blocking effects.

Additional aspects and/or advantages will be set forth in part in the description which follows and, in part, will be apparent from the description, or may be learned by practice of the invention.

To achieve the above and/or other aspects and advantages, embodiments of the present invention include a method of reducing block noise of a digital image, including deblocking two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

To achieve the above and/or other aspects and advantages, embodiments of the present invention include at least one medium including computer readable code to control at least one processing element to implement at least one of a video encoding method and a decoding method, the method including at least one of encoding an input video frame and decoding the encoded frame in an encoding operation and restoring the encoded frame from an input bitstream in a decoding operation, and performing of deblocking of two neighboring blocks that respectively make up one of the corresponding encoded frame, decoded frame, or restored video frame based upon which of the encoding and decoding operation the method is performing, wherein the deblocking includes deblocking the two neighboring blocks according to a classification of a boundary block as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

To achieve the above and/or other aspects and advantages, embodiments of the present invention include a system to reduce block noise of a digital image, including a deblocking-performing unit to perform deblocking of two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

To achieve the above and/or other aspects and advantages, embodiments of the present invention include at least one medium including computer readable code to control at least one processing element to implement a deblocking of two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates blocking effects appearing when the original image is compressed;

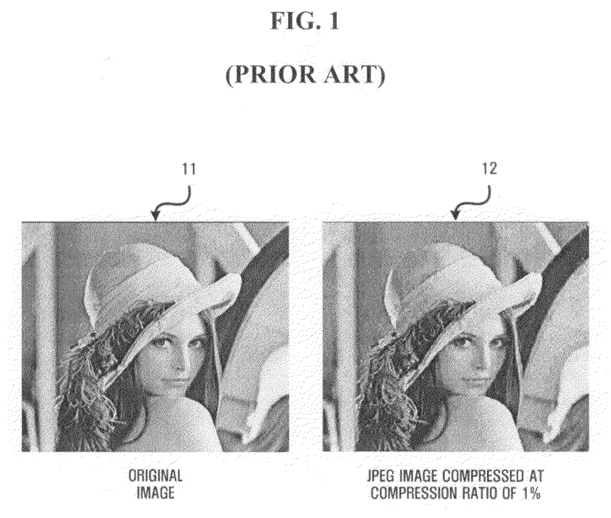

FIG. 2 illustrates a concept of blocks used according to an embodiment of the present invention;

FIG. 3 illustrates a method of reducing block noise of a digital image, according to an embodiment of the present invention;

FIG. 4 illustrates a comparison of an image before normalization with an image after normalization;

FIG. 5 illustrates images obtained by classifying a boundary block into three groups, according to an embodiment of the present invention;

FIG. 6 illustrates a step function and a linear function, according to an embodiment of the present invention;

FIG. 7 illustrates a system reducing block noise of a digital image, according to an embodiment of the present invention;

FIG. 8 illustrates a comparison of an original image, a restored image for which no deblocking filter has been used, and a restored image obtained by application of a method of reducing block noise, according to an embodiment of the present invention;

FIG. 9A illustrates a JPEG-compressed image; and

FIG. 9B illustrates an image obtained by restoring the JPEG-compressed image using a method of reducing block noise, according to an embodiment of the present invention.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are described below to explain the present invention by referring to the figures.

Since video coding may be performed with respect to many blocks in a frame, a decoded video may show boundary lines between blocks. Accordingly, deblocking may be performed to smooth such boundary lines, and a deblocking filter may, thus, be used to perform this smoothing. If the strength or effectiveness of the deblocking filter is increased, a greater smoothing effect can be achieved and the observed boundary lines between the blocks can disappear. However, the use of this deblocking filter may also result in valuable information disappearing, which has an important effect upon performance.

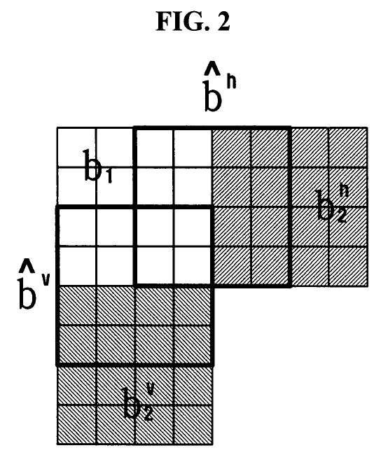

As noted, one or more the embodiments of the present invention include a method, medium, and system removing blocking artifacts using image information coded in a frequency domain through modeling of the blocking artifacts through an algorithm for reducing the blocking artifacts occurring in an image compression/restoration process. Here, a modeling of respective blocks will now be further described with reference to FIG. 2.

FIG. 2 illustrates a concept of blocks used according to an embodiment of the present invention. As shown in FIG. 2, in this example, it should be assumed that in a spatial domain, a horizontally neighboring block of a first block b₁ is a second horizontal block b₂^{h}, and a vertically neighboring block of the first block b₁ is a second vertical block b₂^{v}. In addition, it should be assumed that a 4*4 boundary block between the first block b₁ and the second horizontal block b₂^{h} is a horizontal boundary block \hat{b}^{h}, and a 4*4 boundary block between the first block b₁ and the second vertical block b₂^{v} is a vertical boundary block \hat{b}^{v}. In this case, the size of a block used in such embodiments of the present invention, for example, can be adjusted according to a compression technique to which an embodiment of the present invention is applied, and it may be desirable that the removal of the blocking effects be performed with respect to an 8*8 block, and then the removal of the blocking effects that remain in corner parts be performed with respect to a 4*4 block. However, for convenience and brevity of explanation, herein, only the removal of blocking effects with respect to a 4*4 block will be described, noting that alternatives are equally available. For example, in the case of an 8*8 block, it may be desirable to consider only the dimension caused by the change of the block size.

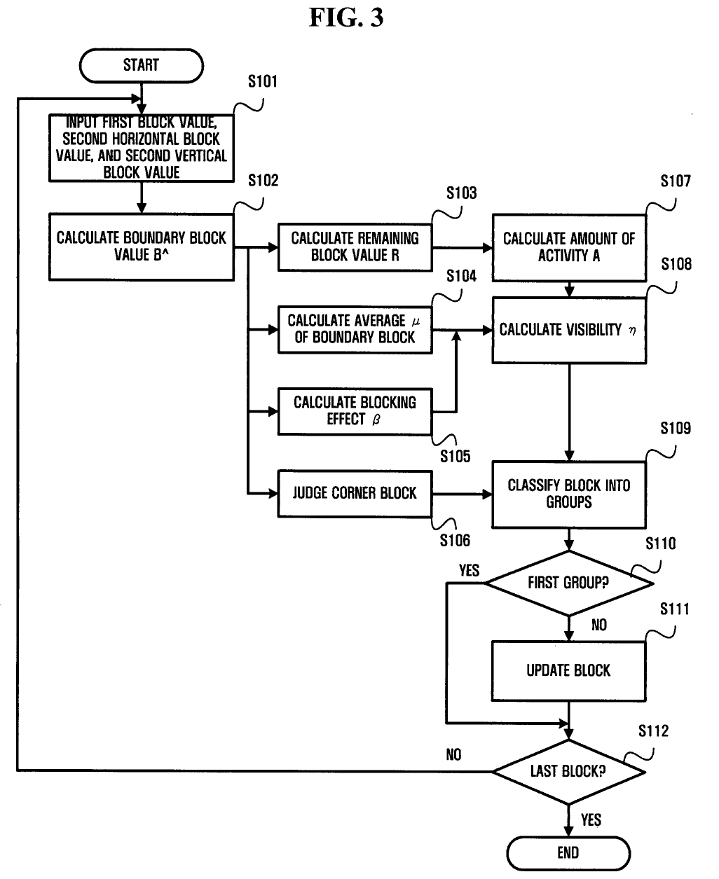

A method of reducing block noise in a digital image, according to an embodiment of the present invention, will now be further described with reference to FIG. 3.

First, below matrices q1 and q2 may be defined according to the below Equation 1, for example.

$${q}_{1} = [ \begin{matrix}0 & 0 & 0 & 0 \\ 0 & 0 & 0 & 0 \\ 1 & 0 & 0 & 0 \\ 0 & 1 & 0 & 0\end{matrix} ] , {q}_{2} = [ \begin{matrix}0 & 0 & 1 & 0 \\ 0 & 0 & 0 & 1 \\ 0 & 0 & 0 & 0 \\ 0 & 0 & 0 & 0\end{matrix} ] \qquad Equation 1$$

Using these matrices, each of the horizontal boundary block \hat{b}^{h} and the vertical boundary block \hat{b}^{v}; can be expressed as a linear combination of two overlapping blocks. That is, the first block value, the second horizontal block value, and the second vertical block value may be input, in operation S101 of FIG. 3. The value of the horizontal boundary block \hat{b}^{h}, which includes the boundary of the first block b₁ and the second horizontal block b₂^{h}, may be calculated using values of the first block b₁ and the second horizontal block b₂^{h}. In addition, the value of the vertical boundary block \hat{b}^{v}, which includes the boundary of the first block b₁ and the second vertical block b₂^{v}, may be calculated using values of the first block b₁ and the second vertical block b₂^{v}. The results of such a calculation may be expressed by the below Equation 2, for example.

\hat{b}^{h}=b₁1₁+b₂^{h}q₂

\hat{b}^{v}=b₁q₂+b₂^{v}q₁ Equation 2

By performing a DCT transform of Equation 2, the following results may be obtained, in operation S102 of FIG. 3, shown by the below Equation 3, for example.

\hat{B}^{h}=B₁Q₁+B₂^{h}Q₂

\hat{B}^{c}=Q₂B₁+Q₁B₂^{u} Equation 3

In addition, the boundary block having the blocking effects may be modeled by a two-dimensional (2D) step function. If it is assumed that the 2D step function of the boundary block in a horizontal direction (e.g., the horizontal boundary block) is denoted by s^{h}(i, j), and the 2D step function of the boundary block in a vertical direction (e.g., vertical boundary block) is denoted by s^{v}(i,j), they have the following values, according to Equation 4, for example.

$${s}^{h} ( i , j ) = \{ \begin{matrix}- \frac{1}{4} , & i = 0 , … , 3 ; & j = 0 , 1 \\ \frac{1}{4} , & i = 0 , … , 3 ; & j = 2 , 3\end{matrix} \\ {s}^{v} ( i , j ) = \{ \begin{matrix}- \frac{1}{4} , & i = 0 , 1 ; & j = 0 , … , 3 \\ \frac{1}{4} , & i = 2 , 3 ; & j = 0 , … , 3\end{matrix} \qquad Equation 4$$

Using Equation 4, each of the horizontal boundary block \hat{b}^{h} and the vertical boundary block \hat{b}^{v} can be expressed as interference of a block having the block effects, according to below Equation 5, for example.

\hat{b}^{v}=β^{v}s^{v}(i,j)+μ^{v}+r^{v}(i,j)

\hat{b}^{h}=β^{h}s^{h}(i,j)+μ^{h}+r^{h}(i,j) Equation 5

Here, μ denotes the average value of the boundary block, s denotes a blocking effect (e.g., the 2D step function), and coefficient β denotes the degree of the blocking effect, respectively; r further denotes the remaining block value, which represents a difference between the block value and the average value in the case where no blocking effect exists. That is, r represents a degree of change in the block around the average. If it is assumed that results of performing the discrete cosine transform (DCT) of s^{h}(i,j) and s^{v}(i,j) are S^{h}(i,j) and S^{v}(i,j), respectively, since s^{h}(i,j) has no change in a vertical direction, only values of the first row of S^{h}(i,j) are significant, and all values of the remaining rows become zero. In addition, since s^{h}(i, j) is in the form of an odd function in a horizontal direction, only S^{h}(0,1) and S^{h}(0,3) have values that are not zero. In the same manner, since s^{v}(i, j) is in the form of an odd function in a horizontal direction, only S^{v}(1,0) and S^{v}(3,0) have values that are not zero, and the remaining values are all zero. In addition, since S^{h}(0,1)=S^{v}(1,0) and S^{h}(0,3)=S^{v}(3,0), the first row of S^{h}(i, j) may be set as a vector v=[v₀, v₁, v₂, v₃]. The result of performing DCT transform of s^{h}(i,j) is shown in the below Equation 6, for example.

$$v = [ \begin{matrix}0.0 , & - 0.924 , & 0.0 , & 0.383\end{matrix} ] \\ \begin{matrix}s ( i , j ) = [ \begin{matrix}- 1 / 4 & - 1 / 4 & 1 / 4 & 1 / 4 \\ - 1 / 4 & - 1 / 4 & 1 / 4 & 1 / 4 \\ - 1 / 4 & - 1 / 4 & 1 / 4 & 1 / 4 \\ - 1 / 4 & - 1 / 4 & 1 / 4 & 1 / 4\end{matrix} ] S \\ = [ \begin{matrix}0 & {v}_{1} & 0 & {v}_{3} \\ 0 & 0 & 0 & 0 \\ 0 & 0 & 0 & 0 \\ 0 & 0 & 0 & 0\end{matrix} ]\end{matrix} \qquad Equation 6$$

A process of calculating the visibility of the boundary block through the extraction of many characteristic values of the vertical boundary block and the vertical boundary block will be further described according to the following. The characteristic values may include an average value μ of the boundary block, the remaining block value r representing a difference between the value of the boundary block and the average value, and a value β representing the degree of blocking effect, for example.

In order to obtain the remaining block value among the characteristic values, the respective terms of Equation 5 are DCT-transformed, and then arranged for the remaining block R to obtain the below Equation 7, for example.

R^{h}(i,j)=\hat{B}^{h}(i,j)−β^{h}S^{h}(i,j)−μ^{h}

R^{v}(i,j)=\hat{B}^{v}(i,j)−β^{v}S^{v}(i,j)−μ^{v} Equation 7

Here, to prevent duplicate expressions and for explanatory convenience, only the horizontal (e.g., transverse) direction is considered unless otherwise mentioned, noting that alternatives are also available. Based on Equation 7, the value of the remaining block R may further be determined, in operation S103 of FIG. 3. As described above, since only the values of the first row of S^{h}(i,j) are significant, and all values of the remaining rows are zero, the value of the remaining block R can be determined in the following order. The DCT coefficient value B̂^{h} for the boundary block may be substituted for the boundary block, and then the average value μ^{h} may be subtracted from the resultant value by making the DC component zero. Then, in order to remove the blocking component, the value β^{h}vⱼ obtained by multiplying the respective coefficient of the first row by β^{h} may be subtracted from the DCT coefficient value B̂^{h} of the boundary block, according to the below Equation 8, for example.

R^{h}=B̂^{h}

R^{h}(0,0)=0

R^{h}(0,j)=B̂^{h}(0,j)−β^{h}vⱼ, (j=1,3) Equation 8

Thereafter, the average value μ^{h} in the boundary block and the degree of blocking effect β^{h} may be further obtained using the below Equation 9, for example, in operations S104 and S105 of FIG. 3.

μ^{h}=\hat{B}(0,0)/4

β^{h}=v₁\hat{B}(0,1)+v₃\hat{B}(0,3) Equation 9

The average value μ^{h} can be obtained by dividing the DC component of the DCT-transformed value by 4, for example, as the block length as stated in Equation 9, instead of obtaining it in the spatial domain in operation S104 of FIG. 3. In addition, β^{h} may be obtained by extracting the component of the step function, which is not zero, from the DCT coefficients of the boundary block.

However, even if either of B̂^{h}(0,1) and B̂^{h}(0,3) has a large value, the value of β^{h} becomes large, which results in the corresponding boundary block being classified into the group that has a large number of step function components although the boundary block actually has a small number of step function components. Accordingly, it is desirable to normalize the respective components of the vector v in order to obtain a more accurate result. The following Equation 10, for example, may be used for the normalization.

vⱼ=vⱼ min(\hat{B}^{h}(0,1)/v₁,\hat{B}(0,3)/v₃)/\hat{B}^{h} (0,j) Equation 10

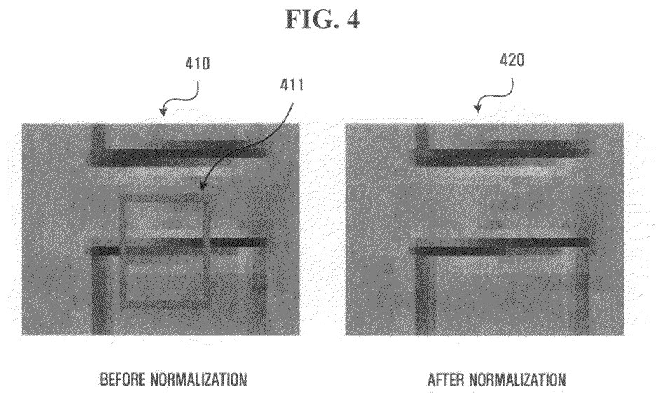

If the normalization is performed, an erroneous process due to the above-described erroneous calculation of the step function components may be prevented. This can be seen in FIG. 4, which demonstrates an image before normalization and an image after normalization. Referring to FIG. 4, it can be seen that the blocks are erroneously classified with a tetragonal illuminated portion 411 in the image 410 appearing blurred, compared a similar area in image 420 not appearing as blurred.

In addition, if the absolute value of the DCT coefficient is large, in spite of the small number of step function components in Equation 9, the value of β^{h} becomes large and causes an erroneous classification of the boundary block, which may, thus, cause the picture quality to deteriorate. In order to prevent this, if the step function components do not satisfy their sign relation, the value of β^{h} may be determined to be β^{h}=0. For example, if the block size is 4, for example, the vector becomes v=[0.0, −0.924, 0.0, 0.383], and if the block size is 8, for example, the vector becomes v=[0.0, −0.906, 0.0, 0.318, 0.0, −0.213, 0.0, 0.180]. If the multiplication of the second component by the fourth component of the first row (expressed by the vector v) of the DCT coefficient is (+) in a state that the block size is 4, the value of β^{h} may be determined to be β^{h}=0, while if the multiplication is (+) in a state that the block size is 8, the value of β^{h} may also determined to be β^{h}=0.

Although the above-described embodiment has been described through a calculating of DCT coefficients of the decoded image signal, it may also be directly performed with respect to an encoded image that has not been decoded in a DCT domain.

Accordingly, thereafter, it may be judged whether the boundary block is a corner block, in operation S106 of FIG. 3. In order to judge whether the boundary block is a corner block, a high-pass filtering, such as Sobel filtering, may be performed using an image composed of average values of the boundary block only, for example. If the resultant value exceeds a specified threshold value, the boundary block may be classified as a corner block. In an embodiment, since the Sobel filtering is performed in both horizontal and vertical directions, corner blocks in a horizontal direction and in a vertical direction may be separately obtained.

Thereafter, an amount of activity Aₕ inside a horizontal boundary block may be calculated, e.g., using the sum of weight values of the remaining block R^{v} to a vertical boundary block, and an amount of activity Aᵥ inside the vertical boundary block may be calculated, e.g., using the sum of weight values of the remaining block R^{h} to the horizontal boundary block, in operation S107 of FIG. 3. As only examples, in such an embodiment, techniques of texture masking (or activity masking) and luminance masking (or brightness masking) exist as representative mechanisms for a masking process that prevents the human visual system from perceiving the blocking effect. Such a texture masking prevents the human visual system from perceiving the blocking effect due to the change in the boundary block. The corner in the vertical direction corresponds to the change in the horizontal direction in a frequency domain, and the corner in the horizontal direction corresponds to the change in the vertical direction in the frequency domain. If it is assumed that the amounts of activity in the vertical and horizontal directions are Aᵥ and Aₕ, respectively, in a boundary block, they can be calculated by expressing them as the sum of weight values of the remaining block value R, according to the below Equation 11, for example.

$${A}_{v} = {\sum }_{v = 1}^{3} v { \sum }_{u = 0}^{3} \vert {R}^{h} ( u , v ) \vert \\ {A}_{h} = {\sum }_{u = 1}^{3} u {\sum }_{ v = 0}^{3} \vert {R}^{v} ( u , v ) \vert \qquad Equation 11$$

In the case of B̂^{h} of the horizontal boundary block, the masking effect may be closely related to the corner in the vertical direction, and thus Aᵥ can be superior, as in the below Equation 12, for example. By contrast, in the case of B̂^{v} of the vertical boundary block, the corner in the horizontal direction may be superior.

A^{h}ₜₒₜₐₗ=Aᵥ+0.8Aᵥ

A^{v}ₜₒₜₐₗ=Aₕ+0.8Aᵥ Equation 12

Then, the visibility of the blocking effect may be obtained using the calculated amount of activity, the average value, and the degree of the blocking effect, in operation S108 of FIG. 3. This is related to the luminance masking work, which corresponds to a phenomenon that the blocking effect is not perceived due to the brightness of the background. The visibility η^{h} of the blocking effect of the horizontal boundary block can be expressed by mathematical functions of the amount of activity A^{h}ₜₒₜₐₗ and the average brightness μ^{h} of the boundary block, according to the below Equation 13, for example.

$${η}^{h} = \frac{\vert {β}^{h} \vert}{( 1 + {( \frac{{A}_{total}^{h}}{{a}_{0}} )}^{a} ) ( 1 + {( \frac{μ}{{μ}_{0}} )}^{v} )} \qquad Equation 13$$

Referring to Equation 13, if the activity is high in the horizontal direction (e.g., A^{h}ₜₒₜₐₗ has a large value) or the background (e.g., average value of brightness) is bright (e.g., μ^{k} has a large value) in the boundary block, the visibility η^{k} of the blocking effect is lowered and thus the human visual system cannot perceive the blocking effect. That is, the visibility is inversely proportional to the amount of activity and the average value, and is in proportion to the value representing the degree of the blocking effect. In Equation 13, a and a₀ are parameters which identify the degree of activity that affects the visibility of the blocking effect, and as a result of experiments with diverse images, in one embodiment, their preferable values turned out a=2 and a₀=8, respectively, for example.

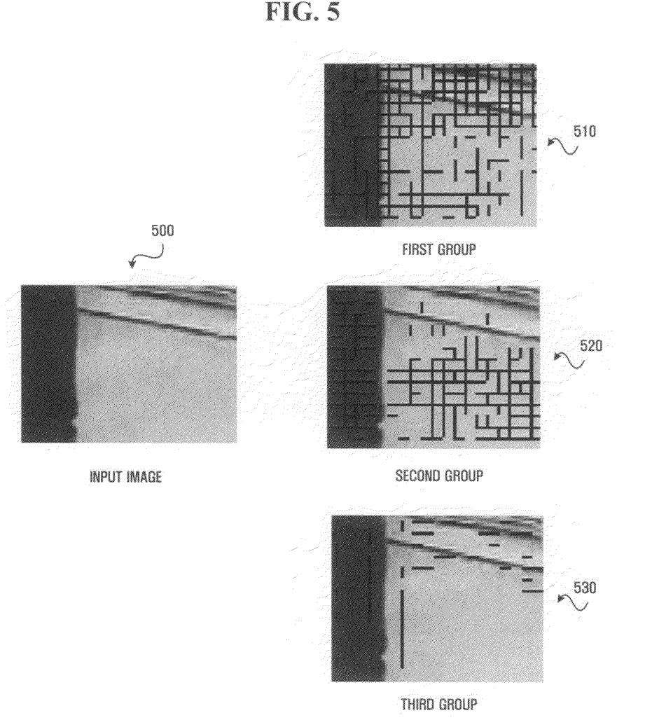

The boundary block can be classified into three groups according to the result of a comparing of the visibility η^{h} calculated in Equation 13 with a specified threshold value τ and according to whether the two neighboring blocks are corner blocks, in operation S109 of FIG. 3. In an embodiment, the first group may be a group in which the visibility η^{h} is smaller than the threshold value, the second group may be a group in which the visibility is larger than the threshold value and the two neighboring blocks are not corner blocks, and the third group may be a group in which the visibility is larger than the threshold value and either of the two neighboring blocks is a corner block. Such first through third groups are illustrated in FIG. 5.

Accordingly, FIG. 5 illustrates images obtained by classifying a boundary block into three groups, e.g., according to the above embodiment of the present invention. In comparison to the shown input image 500, the image of the first group 510 includes substantial changes on its boundary and includes many upper parts having a large amount of activity and a small number of step function components. In this group, it can be judged that typically a human cannot recognize the blocking effects, and thus no additional process may be required. The image of the second group 520 clearly shows the blocking effects on its lower parts, although two overlapping blocks are not corner blocks and thus require no change on their boundaries. The image of the third group 530 has non-smooth boundary parts although the blocking effects are not clearly seen, and thus requires additional image improvement. Thus, in such an embodiment, it may be preferable to perform a slight blurring with respect to the image of the third group.

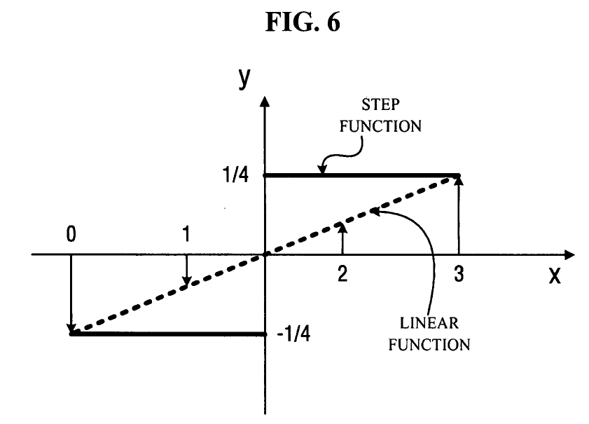

According to one or more embodiments, a further process of performing deblocking for an improvement of images with such classified groups will now be described in greater detail. Thus, here, it may be judged whether the classified group is a first group, in operation S110 of FIG. 3, and if the classified group is not the first group, the deblocking may be performed to update the block, in operation S111 of FIG. 3. Thus, in this example, the second group and the third group require the block update. The deblocking of the image of the second group will be further described with reference to FIG. 6.

FIG. 6 illustrates a step function and a linear function, according to an embodiment of the present invention. The boundary blocks classified into the second group may reduce the component of the step function and increase the linear component. Since the component of the illustrated step function generates the blocking effect in a spatial domain, the blocking effect in the spatial domain can be reduced by linearly deforming the component of the step function without any discontinuities. In order to define the above-described 2D step function s^{h}, a one-dimensional linear function g(x) may be defined according to the following Equation 14, for example.

$$g ( x ) = \frac{1}{6} x \qquad Equation 14$$

Here, in this example, if it is assumed that d is d=[g(−1.5), g(−0.5), g(0.5), g(1.5)] and a 2D function obtained by expanding this into four rows is I^{h}, it can be expressed according to the below Equation 15, for example.

$${I}^{h} = [ \begin{matrix}- 1 / 4 & - 1 / 12 & 1 / 12 & 1 / 4 \\ - 1 / 4 & - 1 / 12 & 1 / 12 & 1 / 4 \\ - 1 / 4 & - 1 / 12 & 1 / 12 & 1 / 4 \\ - 1 / 4 & - 1 / 12 & 1 / 12 & 1 / 4\end{matrix} ] \qquad Equation 15$$

Thus, it can be seen that this matrix has the properties of an odd function that is symmetrical in a horizontal direction and has no change in a vertical direction. Using these properties, only the first row of the matrix may be stored in the form of λ^{h}=[λ₀,λ₁,λ₂,λ₃], after the DCT transform thereof is performed. By removing the influence of the step function s^{h} from Equation 15 and adding the influence of the linear function I^{h} to Equation 15, \hat{b}^{h′}, which is an improvement of \hat{b}^{h}, can be further obtained according to the below Equation 16, for example.

$$\begin{matrix}{\hat{b}}^{{h}^{′}} ( i , j ) = {\hat{b}}^{h} ( i , j ) - {β}^{h} {s}^{h} ( i , j ) + {β}^{h} {l}^{h} ( i , j ) \\ = {\hat{b}}^{h} ( i , j ) + {β}^{h} \{ {l}^{h} ( i , j ) - {s}^{h} ( i , j ) \}\end{matrix} \\ i , j = 0 , … , 3 \qquad Equation 16$$

By performing the DCT transform with respect to Equation 16, the results shown in following Equation 17 may be achieved, for example.

\hat{B}^{h′}(0,j)=\hat{B}^{h}(0,j)+β^{h}δ

\hat{B}^{h′}(i,j)=\hat{B}^{h}(i,j), i≠0,j=0, . . . , 3 Equation 17

Here, the terms of I^{h} and s^{h} can be expressed using λ and v, their first rows, respectively. Further, in Equation 17, δ=λ−v.

Next, the deblocking of two neighboring blocks may be performed by correcting B₁ and B^{h}₂ using Equation 17. As an example, in order to divide the contents of the updated \hat{b}^{h′} into the two neighboring blocks, an algorithm as expressed by the following Equations 18 and 19, for example, may be is performed using the matrices Q₁ and Q₂.

δ₁=δQ₂

δ₂=δQ₁ Equation 18

B₁(0,j)=B₁(0,j)+β^{h}(δ₁)ⱼ j=0, . . . , 3

B₂^{h}(0,j)=B₂^{h}(0,j)+β^{h}(δ₂)ⱼ j=0, . . . , 3 Equation 19

Although the above algorithm may be used with respect to the second group, some discontinuity may remain. In this case, a spatial blurring may be performed with respect to the boundary surface. In the same manner, the blurring may also be performed with respect to the image of the third group 530, for example.

If it is judged that the classified group corresponds to the first group in operation S110, or the updating process is completed in operation S111, it may be judged whether the corresponding block is the last block, in operation S112. If the block is the last block, the process may be terminated, while if the block is not the last block, the process may return to the initial stage, in operation S101.

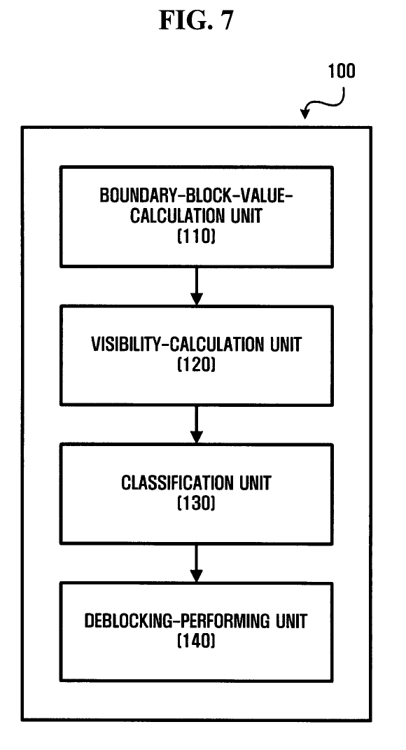

FIG. 7 illustrates a system 100 reducing block noise of a digital image, according to an embodiment of the present invention. According to one or more embodiments the illustrated system 100 includes an encoding unit or decoding system for making up a corresponding encoding system or decoding system that implements encoding and/or decoding of image data, including computational systems where the system 100 is also a display or included in a display system, or may be a system separate from such a display for providing image data for either further transmission or display, noting that alternative embodiments are equally available.

Thus, here, an example boundary-block-value-calculation unit 110 may calculate a value of a boundary block that includes a boundary between two neighboring blocks. The boundary-block-value-calculation unit 110 may further include a horizontal boundary-block-value-calculation unit, for example, calculating a value of a horizontal boundary block that includes the boundary of a first block of a specified size and a second horizontal block horizontally neighboring the first block using values of the first block and the second horizontal block and a vertical boundary-block-value-calculation unit, for example, calculating a value of a vertical boundary block that includes a boundary of the first block and a second vertical block vertically neighboring the first block using values of the first block and the second vertical block, alternate embodiments are also available.

The system 100 may further include an example visibility-calculation unit 120, which may include a characteristic-value-calculation unit and an activity-calculation unit, for example, and may calculate the visibility of the boundary block. The characteristic-value-calculation unit may calculate an average value of the boundary block, a value of the remaining block representing a difference between the value of the boundary block in the case where no blocking effect exists and the average value, and a value representing a degree of the blocking effect, for example. The activity-calculation unit may calculate an amount of activity inside the boundary block using the value of the remaining block. In addition, in an embodiment, the activity-calculation unit may, for example, calculate an amount of activity inside a horizontal boundary block using the sum of weight values of the remaining block to a vertical boundary block, and calculate an amount of activity inside the vertical boundary block using the sum of weight values of the remaining block to the horizontal boundary block.

In this case, the visibility-calculation unit 120 may calculate the visibility of the blocking effect using the amount of activity, the average value, and the degree of the blocking effect, for example. The visibility is in reverse proportion to the amount of activity and the average value, and in proportion to the value representing the degree of the blocking effect.

The classification unit 130 may classify the boundary block according to the result of comparing the calculated visibility with a specified threshold value and whether the two neighboring blocks are corner blocks, for example. In an embodiment, it may be preferable that the classification block 130 classifies the boundary blocks into first through third groups, e.g., a first group in which the visibility of the blocking effect is smaller than the threshold value, a second group in which the visibility is larger than the threshold value and the two neighboring blocks are not corner blocks, and a third group in which the visibility is larger than the threshold value and either of the two neighboring blocks is a corner block, noting that alternatives are again available.

The deblocking-performing unit 140 may further perform the deblocking of the two neighboring blocks according to the result of classification, for example. In the above embodiment, if the boundary block corresponds to the first group, the deblocking may not be performed. If the block corresponds to the second group, the boundary block value may be updated using the algorithm by removing the influence of the step function from the boundary block value and adding the influence of the linear function to the boundary block value. Still further, if the block corresponds to the third group, in this example, the blurring process may be performed with a slight intensity.

Herein, although one or more embodiments of the present invention have described a deblocking process performed as a method, for example, of reducing the deblocking effect through the performing of the DCT transform of the decoded image, it is also possible to directly perform such a deblocking at an encoding operation without performing any additional decoding process with respect to the image encoded in the unit of a block, for example. Such additional embodiments can equally be implemented through a system and medium, in differing embodiments.

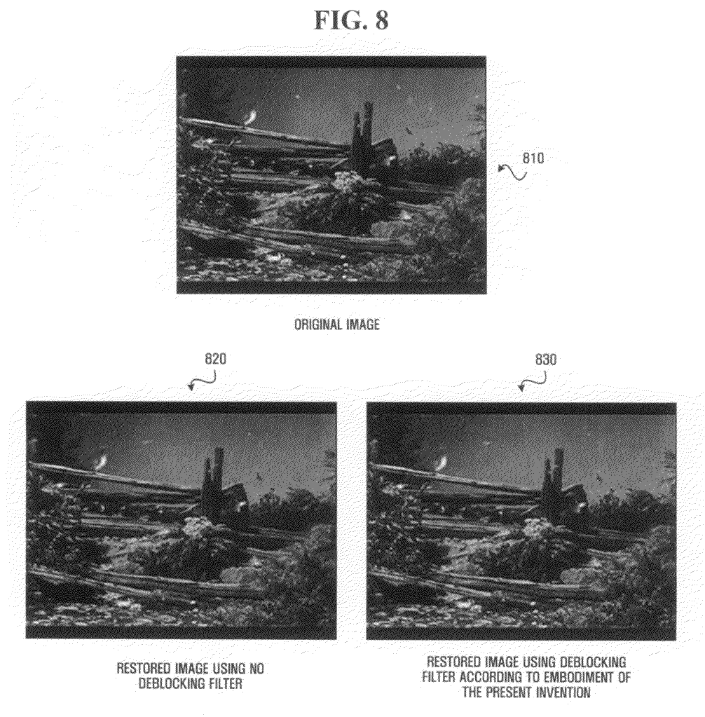

In addition, FIG. 8 illustrates a comparison of an example original QVGA image 810 (e.g., with a resolution of 320*240), a restored image 820 where no example deblocking filter has been used, and a restored image 830 where an example method of reducing block noise, according to an embodiment of the present invention, has been used. Referring to FIG. 8, it can be seen that the restored image 830 processed by such an example deblocking filter has remarkably reduced blocking artifacts compared to the restored image 820, processed using the aforementioned example H.264 conventional standard at 256 kbps.

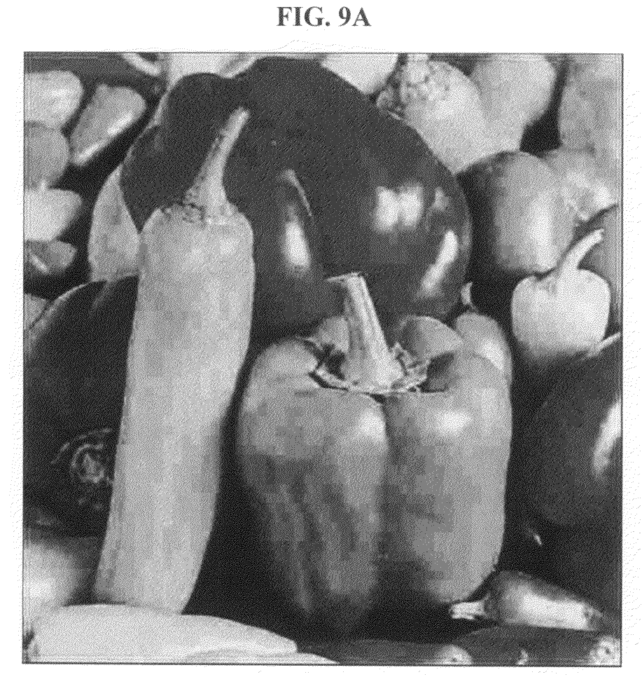

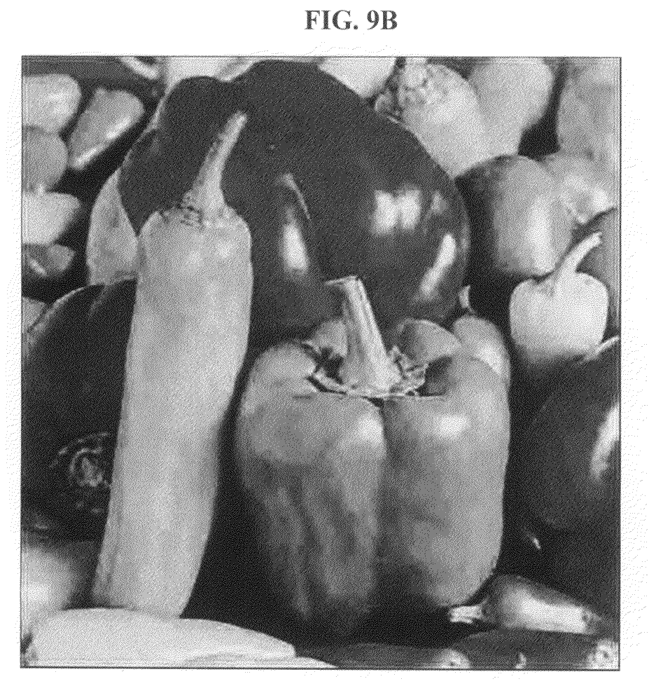

FIG. 9A illustrates a further example JPEG-compressed image, and FIG. 9B illustrates an image obtained by restoring the FIG. 9A JPEG-compressed image using a method of reducing block noise, according to an embodiment of the present invention. The image illustrated in FIG. 9A is an image that has been compressed from 768 kilobytes to 7433 bytes. By using a deblocking filter, according to an embodiment of the present invention, an improved resultant image having reduced blocking artifacts as shown in FIG. 9B can thus be obtained.

Above, though one ore more embodiments of the present invention may have been described with reference to 4*4 blocks, embodiments of the present invention are not limited thereto. For example, an embodiment of the present invention may also be applied to a macroblock, a slice, a frame, etc.

In one or more embodiments of the present invention, the term “unit”, such as the elements illustrated in FIG. 7, means, but is not limited to, a software and/or hardware component, such as a Field Programmable Gate Array (FPGA) or an Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operability provided for in the components and units may be combined into fewer components and units or further separated into additional components and units. In addition, the components and units may be implemented so as to execute one or more CPUs in a device or a secure multimedia card, for example.

With that being said, and in addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, blocking effects can be reduced, and an image having a high picture quality can be generated.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of reducing block noise of a digital image, comprising:
deblocking two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

2. The method of claim 1, for calculating the value of the boundary block, the method further comprises:
calculating a value of a horizontal boundary block that includes a boundary of a first block of a specified size and a second horizontal block horizontally neighboring the first block by using values of the first block and the second horizontal block; and
calculating a value of a vertical boundary block that includes a boundary of the first block and a second vertical block vertically neighboring the first block by using values of the first block and the second vertical block.

3. The method of claim 2, further comprising performing a discrete cosine transform of the value of the horizontal boundary block and the value of the vertical boundary block if the two neighboring blocks are blocks that make up a decoded image.

4. The method of claim 1, wherein, for the calculating of the visibility of the boundary block, the method further comprises:
calculating an average value of the boundary block, a value of a remaining block representing a difference between the value of the boundary block when no blocking effect exists and the average value, and a value representing a degree of a blocking effect of the boundary block;
calculating an amount of activity inside the boundary block by using the value of the remaining block; and
calculating a visibility of the blocking effect by using the amount of activity, the average value, and the value representing the degree of the blocking effect.

5. The method of claim 4, wherein the calculating of the amount of activity inside the boundary block by using the value of the remaining block further comprises calculating an amount of activity inside a horizontal boundary block by using a sum of weight values of the remaining block to a vertical boundary block, and calculating an amount of activity inside the vertical boundary block by using a sum of weight values of the remaining block to the horizontal boundary block.

6. The method of claim 4, wherein the visibility of the boundary block is inversely proportional to the amount of activity inside the boundary block and the average value, and is in proportion to the value representing the degree of the blocking effect.

7. The method of claim 1, wherein, for the calculating of the visibility of the boundary block, the method further comprises calculating a visibility for a vertical boundary block and a visibility for a horizontal boundary block.

8. The method of claim 1, wherein, for the classifying of the boundary block, the method further comprises classifying the boundary block into a first group in which a visibility of a corresponding blocking effect is smaller than a threshold value, a second group in which the visibility of the corresponding blocking effect is larger than the threshold value and the two neighboring blocks are not corner blocks, and a third group in which the visibility of the corresponding blocking effect is larger than the threshold value and at least one of the two neighboring blocks is a corner block.

9. The method of claim 8, wherein the deblocking of the two neighboring blocks further comprises performing no deblocking of the neighboring blocks upon a determination that the boundary block corresponds to the first group, correcting the value of the boundary block by using a specified algorithm upon a determination that the boundary block corresponds to the second group, and performing a blurring process with a selective predetermined intensity upon a determination that the boundary block corresponds to the third group.

10. The method of claim 9, wherein the algorithm is an algorithm that is executed to remove an influence caused by a step function from the value of the boundary block and to add an influence caused by a linear function to the value of the boundary block.

11. The method of claim 1, wherein the method is one of a video encoding method and a video decoding method, the method further comprising:
one of encoding an input video frame and decoding the encoded frame in an encoding operation and restoring the encoded frame from an input bitstream in a decoding operation; and
performing of the deblocking of the two neighboring blocks that respectively make up one of the corresponding encoded frame, decoded frame, or restored video frame based upon which of the encoding and decoding operation the method is performing.

12. At least one medium comprising computer readable code to control at least one processing element to implement at least one of a video encoding method and a decoding method, the method comprising:
at least one of encoding an input video frame and decoding the encoded frame in an encoding operation and restoring the encoded frame from an input bitstream in a decoding operation; and
performing of deblocking of two neighboring blocks that respectively make up one of the corresponding encoded frame, decoded frame, or restored video frame based upon which of the encoding and decoding operation the method is performing,
wherein the deblocking comprises deblocking the two neighboring blocks according to a classification of a boundary block as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

13. A system to reduce block noise of a digital image, comprising:
a deblocking-performing unit to perform deblocking of two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.

14. The system of claim 13, further comprising a boundary-block-value-calculation unit for calculating the value of the boundary block, the boundary-block-value-calculation unit comprising:
a horizontal boundary-block-value-calculation unit to calculate a value of a horizontal boundary block that includes a boundary of a first block of a specified size and a second horizontal block horizontally neighboring the first block by using values of the first block and the second horizontal block; and
a vertical boundary-block-value-calculation unit to calculate a value of a vertical boundary block that includes a boundary of the first block and a second vertical block vertically neighboring the first block by using values of the first block and the second vertical block.

15. The system of claim 14, wherein the boundary-block-value-calculation unit performs a discrete cosine transform of the value of the horizontal boundary block and the value of the vertical boundary block if the two neighboring blocks are blocks that make up a decoded image.

16. The system of claim 13, further comprising a visibility-calculation unit to calculate the visibility of the boundary block, the visibility-calculation unit comprising:
a character-value-calculation unit to calculate an average value of the boundary block, a value of a remaining block representing a difference between the value of the boundary block when no blocking effect exists and the average value, and a value representing a degree of a blocking effect of the boundary block; and
an activity-calculation unit to calculate an amount of activity inside the boundary block by using the value of the remaining block,
wherein the visibility-calculation unit calculates a visibility of the blocking effect by using the amount of activity, the average value, and the value representing the degree of the blocking effect.

17. The system of claim 16, wherein the activity-calculation unit calculates an amount of activity inside a horizontal boundary block by using a sum of weight values of the remaining block to a vertical boundary block, and calculates an amount of activity inside the vertical boundary block by using a sum of weight values of the remaining block to the horizontal boundary block.

18. The system of claim 16, wherein the visibility of the boundary block is inversely proportional to the amount of activity in the boundary block and the average value, and is proportional to the value representing the degree of the blocking effect.

19. The system of claim 13, further comprising a visibility-calculation unit to calculate the visibility of the boundary block, the visibility-calculation unit to calculate a visibility for a vertical boundary block and a visibility for a horizontal boundary block.

20. The system of claim 13, further comprising a classification unit to perform the classifying of the boundary block, the classification unit classifying the boundary block into a first group in which a visibility of a corresponding blocking effect is smaller than a threshold value, a second group in which the visibility of the corresponding blocking effect is larger than the threshold value and the two neighboring blocks are not corner blocks, and a third group in which the visibility of the corresponding blocking effect is larger than the threshold value and at least one of the two neighboring blocks is a corner block.

21. The system of claim 20, wherein the deblocking-performing unit performs no deblocking of the neighboring blocks upon a determination that the boundary block corresponds to the first group, corrects the value of the boundary block by using a specified algorithm upon a determination that the boundary block corresponds to the second group, and performs a blurring process with a selective predetermined intensity upon a determination that the boundary block corresponds to the third group.

22. The system of claim 21, wherein the algorithm is an algorithm that is executed to remove an influence caused by a step function from the value of the boundary block and to add an influence caused by a linear function to the value of the boundary block.

23. The system of claim 13, wherein the system is a display system.

24. The system of claim 13, wherein the system is at least one of a video encoder and video decoder, the system further comprising:
at least one of an encoding unit, to encode an input video frame and a decoding unit to decode the encoded frame during an encoding operation, and a restoring unit to restore the encoded frame from an input bitstream during a decoding operation,
wherein the deblocking-performing unit performs the deblocking of the two neighboring blocks that make up the corresponding encoded and decoded frame based upon which of the encoding operation and the decoding operation the system is performing.

25. At least one medium comprising computer readable code to control at least one processing element to implement a deblocking of two neighboring blocks according to a classification of a boundary block, as a boundary between the two neighboring blocks, based on a value of the boundary block and a comparing of a visibility of the boundary block with a specified threshold value and based upon a determination of whether the two neighboring blocks are corner blocks, wherein the visibility of the boundary block is calculated by extracting specified characteristic values of the boundary block.
